(19) United States
(12) Patent Application Publication
(10) Pub. No.: US 2007/0115212 A1
(43) Pub. Date: May 24, 2007

(54) Method of driving high definition opposed discharge plasma display panel

(75) Inventors: Hsu-Pin Kao, Pingjhen City (TW); Jang-Jeng Liang, Taoyuan City (TW); Tsan-Hung Tsai, Sanchong City (TW); Sheng-Wen Hsu, Taipei City (TW); Hsu-Chia Kao, Pingjhen City (TW)

Correspondence Address: BACON & THOMAS, PLLC, 625 SLATERS LANE, FOURTH FLOOR, ALEXANDRIA, VA, 22314, US

(73) Assignee: MARKETECH INTERNATIONAL CORP., Taipei (TW)

(21) Appl. No.: 11/521,405

(22) Filed: Sep. 15, 2006

(30) Foreign Application Priority Data
Nov. 22, 2005 (TW) 094140919

(51) Int. Cl. G09G 3/28

(52) U.S. Cl. 345/60

(57) ABSTRACT

The present invention is to provide a method of driving a high definition opposed discharge PDP comprising transversely disposing a barrier rib on a center of any elongate discharge cells of the opposed discharge PDP to divide the discharge cell into two sub-cells; disposing a sustain electrode on a front substrate corresponding to either sub-cell; causing a driving circuit to apply a sustaining pulse to each of the plurality of sustain electrodes in a sustaining period of each sub-field; and causing a phase of the sustaining pulse on the sustain electrode corresponding to one sub-cell to have a phase difference of 180 degrees relative to that of the sustaining pulse on the sustain electrode corresponding to the other adjacent sub-cell in order to effectively eliminate noise caused by vibration of the opposed discharge PDP in discharge, reducing peak current and electromagnetic interference, and greatly increase both light emitting efficiency and brightness of the opposed discharge PDP.

### FIELD OF THE INVENTION

The present invention relates to opposed discharge plasma display panels (PDPs), and more particularly to a method of driving a high definition opposed discharge PDP in order to effectively eliminate noise caused by vibration of the opposed discharge PDP in discharge and greatly increase both light emitting efficiency and brightness of the opposed discharge PDP.

### BACKGROUND OF THE INVENTION

A method of manufacturing a conventional opposed alternating current discharge (i.e., AC type) PDP 10 is illustrated in FIG. 1, wherein two different layers are formed on two opposed glass substrates 11 and 12, the peripheries of the glass substrates 11 and 12 are sealed together to form a space between the two glass substrates, specific gas (e.g., helium (He), neon (Ne), xenon (Xe), or argon (Ar)) is mixed in a predetermined ratio and is filled in discharge cells 13 formed within the space between the two glass substrates 11 and 12. The substrate facing a viewer is defined as a front substrate 11 in the PDP as shown in FIG. 1. On the inner side of the front substrate 11, there are sequentially provided with a plurality of parallel transparent electrodes 111, a plurality of bus electrodes 112, a dielectric layer 113, and a protection layer (e.g., MgO) 114. On the inner side of the opposed rear substrate 12, there are sequentially provided with a plurality of parallel data electrodes 121, a dielectric layer 124, a plurality of barrier ribs 122, and phosphor 123 uniformly coated on each of the barrier ribs 122 in which the phosphor 123 can be a red, green, or blue phosphor. In response to applying voltage to the positions of electrodes 111, 112, and 121, the corresponding dielectric layers 113 and 124 discharge in the discharge cell 13 formed between the adjacent barrier ribs 122, enabling the phosphor 123 in the discharge cell 13 to emit light with a corresponding color.

Referring to FIG. 2, in the conventional AC type PDP 10, the electrodes 111 and 112 are typically made by utilizing sputtering and photolithography or printing techniques to form a plurality of spaced, parallel transparent electrodes 111 on the inner side of the front substrate 11, and then utilizing sputtering (or vaporing) and photolithography techniques to form a plurality of bus electrodes 112 on the transparent electrodes 111 in order to decrease line impedance of the transparent electrodes 111 by utilizing the bus electrodes 112. The transparent electrodes 111 (comprising the bus electrodes 112) and the corresponding data electrodes 121 on the rear substrate 12 together form two opposed electrodes. In response to applying voltage to the electrodes 111 and 121, the dielectric layers 113 and 124 perform opposed discharges in the corresponding discharge cell 13. As a result, the mixed gas filled in the discharge cell 13 discharges to emit ultraviolet (UV). And in turn, red, green, and blue light is emitted by the phosphor 123 coated on the discharge cell 13. As a result, an image is shown. The conventional AC type PDP 10 is also called as opposed discharge PDP.

Referring to FIGS. 1, 2, and 3, in the above opposed discharge PDP 10 the parallel data electrodes 121 of the rear substrate 12 are provided on bottom of the dielectric layer 124 and are disposed perpendicularly to the corresponding transparent electrodes (also called as scan electrodes or sustain electrodes) 111 of the front substrate 11 at the positions corresponding to the discharge cells 13. A shadow mask 20 is formed on top of the dielectric layer 124. A plurality of shadow holes 21 of the shadow mask 20 are employed as space for the discharge cell 13. Also, metal conductor around each shadow hole 21 is served as barrier rib 122 around the discharge cell 13.

Referring to FIGS. 1 to 3 again, in the above opposed discharge PDP 10 portion of a shadow mask 20 of a 34″ opposed discharge PDP 10 having Video Graphics Adapter (VGA) resolution is shown. Each pixel containing three discharge cells for emitting red, green, and blue light respectively has a size of 1080 μm×1080 μm. That is, each discharge cell has a size of 360 μm×1080 μm. Referring to FIG. 4, a driving scheme is created by a driving circuit of the PDP 10 for showing each sub-field. The driving scheme comprises three driving sequences, i.e., a first addressing sequence, a second sustaining sequence, and a third erasing sequence wherein, in the addressing sequence, the driving circuit applies a negative voltage pulse to each bus electrode 112. At the same time, the driving circuit applies a positive data pulse to the address electrode 121 based on an image to be displayed. At this time, due to the shadow mask 20 is made by the conductive metal material, electric field in the discharge cell 13 becomes non-uniform, i.e. the electric field adjacent to the wall of the shadow hole 21 (i.e., barrier rib 122) is relatively strong and the electric field at a center of the shadow hole 21 is relatively weak. Discharge first occurs at wall of the shadow hole 21 when an addressing pulse is applied to the discharge cell 13, which enables the charged particles in the discharge cell 13 quickly spread and propagate toward the center of the shadow hole 21 so as to induce an opposed discharge between the bus electrodes 112 and the data electrodes 121. The opposed discharge scheme not only greatly increases light emitting efficiency of the PDP 10 but also obtains advantages such as high contrast, high writing speed, and low cost.

Referring to FIGS. 1 and 2 again, in the above opposed discharge PDP 10 however, the barrier rib 122 of the rear substrate 12 is formed of metal conductor around each shadow hole 21 of the shadow mask 20. Noise generated by the metal barrier rib 122 is far more serious than that generated by a barrier rib formed of the well known glass substrate when discharge occurs in the discharge cell 13. Referring to FIG. 4 again, for the above opposed discharge PDP 10 in the sustaining period a phase of the sustaining pulse of the nth sustain electrode is the same as that of the sustaining pulse of the n+1^{th} sustain electrode. That is, phase of the odd number pixels and that of the even number pixels are the same with respect to voltage shape in the sustaining sequence. Thus, vibration direction of noise generated by the discharge cells 13 in the discharge is the same. As a result, noise is significantly serious. Therefore, if an intimate contact between an inner surface of the front substrate 11 and the shadow mask 20 is not made in the process of manufacturing, gap formed therebetween will further deteriorate the noise problem caused in the opposed discharge PDP 10. Thus, it is desirable to strictly control flatness of the front and rear substrates 11 and 12 and the shadow mask 20 in order to decrease the gap created due to an irrregularity between the front substrate 11 and the shadow mask 20 in the manufacturing process. The decreased gap can effectively decrease the noise problem. However, such strict control results in a great increase of process difficulty and a decreased yield.

Referring to FIGS. 1, 2 and 5, moreover in the above opposed discharge PDP 10 portion of a shadow mask 20 of a 34″ opposed discharge PDP 10 having VGA resolution is shown. Since each pixel contains three discharge cells for emitting red, green, and blue light respectively, each discharge cell corresponding to each shadow hole 21 of the shadow mask 20 has a size of 360 μm×1080 μm and is elongate. Such elongate discharge cells 13 may cause discharge to concentrate on a center thereof. This can greatly decrease light emitting efficiency of phosphor coated on distal ends relative to the center of the discharge cell 13. As a result, the total light emitting efficiency is very low. Thus, a need for improvement exists.

### SUMMARY OF THE INVENTION

After considerable research and experimentation, a method of driving a high definition opposed discharge plasma display panel (PDP) according to the present invention has been devised so as to overcome the above drawbacks (e.g., noise and low light emitting efficiency) of the prior art.

It is an object of the present invention to provide a method of driving a high definition opposed discharge PDP comprising transversely disposing a barrier rib on a center of any one of a plurality of elongate discharge cells in any one of a plurality of pixels of the opposed discharge PDP wherein the discharge cell is divided into two sub-cells by the barrier rib; disposing a sustain electrode on a front substrate corresponding to either sub-cell; causing a driving circuit to apply a sustaining pulse to each of the plurality of sustain electrodes in a sustaining period of each sub-field; and causing a phase of the sustaining pulse on the sustain electrode corresponding to one sub-cell to have a phase difference of 180 degrees relative to that of the sustaining pulse on the sustain electrode corresponding to the other adjacent sub-cell. By utilizing this method, discharge direction of the sub-cell corresponding to odd number pixel is opposite to that of the sub-cell corresponding to even number pixel in order to effectively eliminate noise caused by vibration of the opposed discharge PDP in discharge. Moreover, a reduction of peak current and electromagnetic interference is made possible. In addition, area coated with phosphor is significantly increased because the discharge cell is divided into two sub-cells. As a result, both light emitting efficiency and brightness of the opposed discharge PDP are greatly increased, and thus image with high quality is shown.

One aspect of the present invention the method comprises causing a driving circuit to apply a sustaining pulse to each of the plurality of sustain electrodes; and causing a phase of the sustaining pulse on the sustain electrode corresponding to one sub-cell to have a phase difference of 180 degrees relative to that of the sustaining pulse on the sustain electrode corresponding to the other adjacent sub-cell. By utilizing this method, discharge directions of two adjacent sub-cells of the discharge cell are opposite in order to substantially eliminate noise caused by vibration of the opposed discharge PDP in discharge due to opposite vibration directions.

Another aspect of the present invention the method comprises lighting spaced sub-cells; and causing a waveform of a voltage pulse of one sub-cell is delayed half period (i.e., phase difference of 180 degrees) relative to that of the other spaced sub-cell in a sustaining period in order to let discharge directions of two spaced sub-cells to be opposite with each other. By utilizing this method, the brightness of the opposed discharge PDP decreases to about half of that when both sub-cells are lit. As a result, an overall brightness of the opposed discharge PDP is decreased in order to adjust the brightness of each gray-scale for decreasing a minimum brightness and obtaining a fine image in low gray-scales of the opposed discharge PDP.

The above and other objects, features and advantages of the present invention will become apparent from the following detailed description taken with the accompanying drawings.

### BRIEF DESCRIPTION OF THE DRAWINGS

FIG. 1 is a sectional view of a conventional opposed discharge PDP;

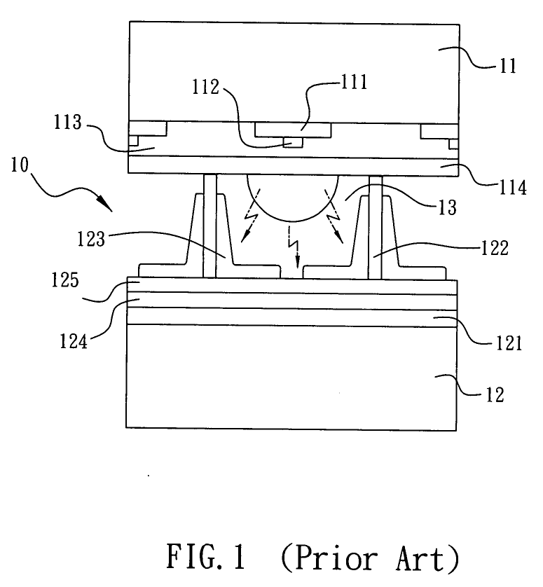

FIG. 2 is an exploded perspective view of the PDP of FIG. 1 showing its front and rear substrates;

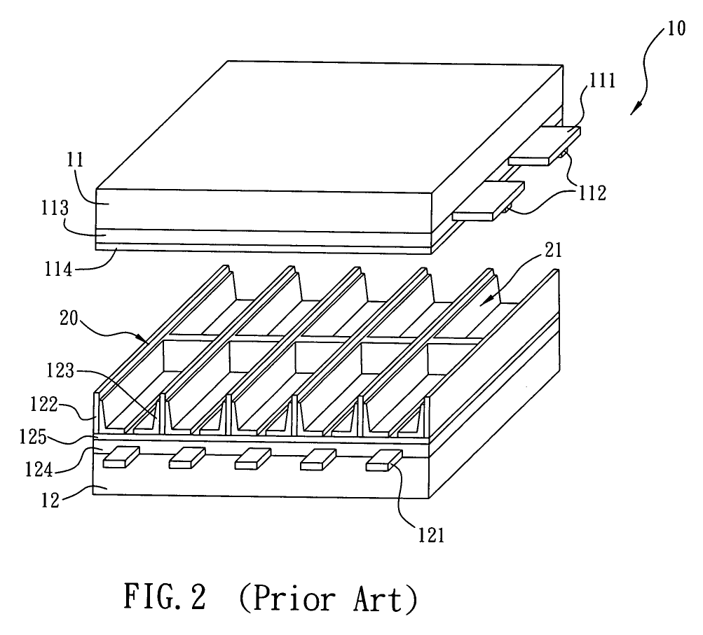

FIG. 3 is a sectional view showing a configuration of the discharge cells, the bus electrodes, and the barrier rib in the PDP of FIG. 1;

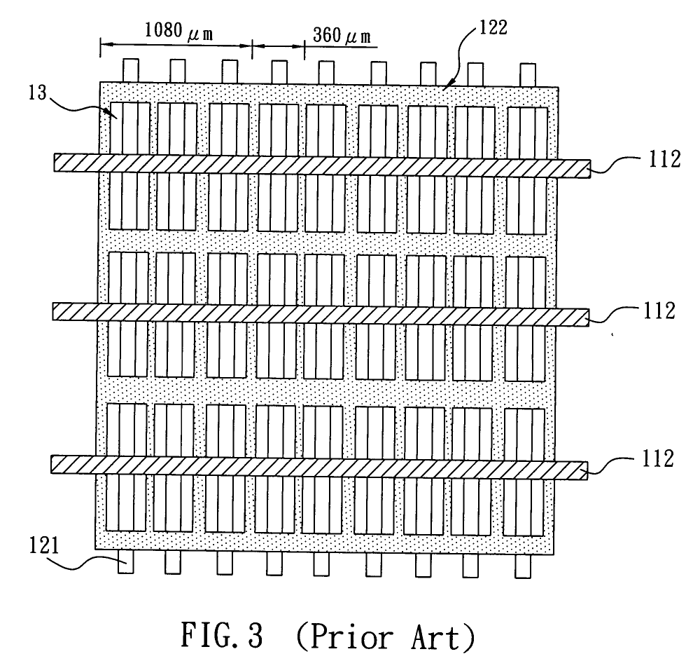

FIG. 4 is a graph of a driving scheme created by a driving circuit of the PDP of FIG. 1 for showing each sub-field;

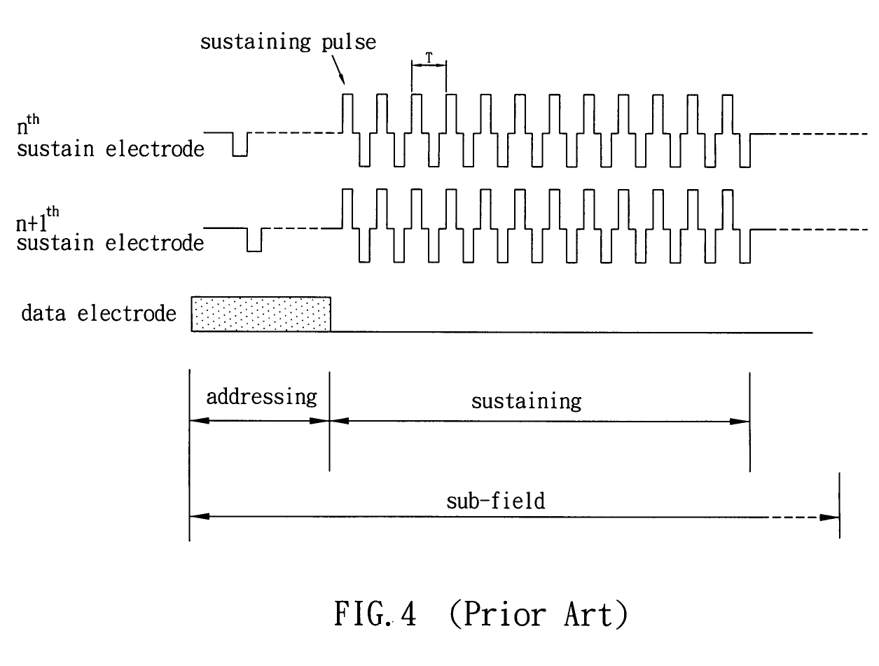

FIG. 5 is a photograph of an enlarged pixel of the PDP of FIG. 1;

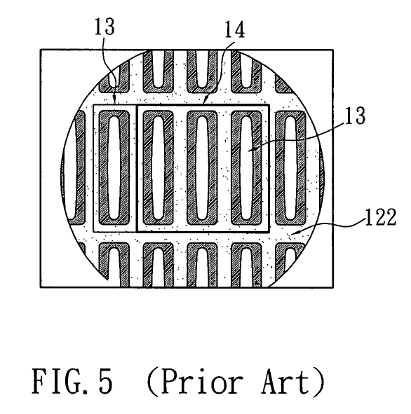

FIG. 6 is a sectional view showing a configuration of discharge cells according to opposed discharge PDP of a first preferred embodiment of the invention;

FIG. 7 is a sectional view showing a configuration the discharge cells, the barrier ribs, and the electrode lines in the PDP of FIG. 6;

FIG. 8 is a graph of a driving scheme created by a driving circuit of the PDP of FIG. 6 for showing each sub-field;

FIG. 9 schematically depicts an opposed discharge between two adjacent sub-cells in discharge where the sub-cells correspond to odd number and even number pixels of the PDP of FIG. 6 respectively;

FIG. 10 is a sectional view showing a configuration of the discharge cells, the barrier ribs, and the electrode lines according to opposed discharge PDP of a second preferred embodiment of the invention;

FIG. 11 is a graph of a driving scheme created by a driving circuit of the PDP of FIG. 10 for showing each sub-field;

FIG. 12 schematically depicts an opposed discharge between two adjacent sub-cells in discharge where the sub-cells correspond to odd number and even number pixels of the PDP of FIG. 10 respectively;

FIG. 13 is a graph of a driving scheme created by a driving circuit of opposed discharge PDP according to a third preferred embodiment of the invention for showing each even number sub-field;

FIG. 14 schematically depicts an opposed discharge between two adjacent sub-cells in discharge where the sub-cells correspond to odd number and even number pixels of the PDP of FIG. 13 respectively;

FIG. 15 is a graph of a driving scheme created by a driving circuit according to the PDP of FIG. 13 for showing each odd number sub-field; and

FIG. 16 schematically depicts an opposed discharge between two adjacent sub-cells in discharge where the sub-cells correspond to odd number and even number pixels of the PDP of FIG. 15 respectively.

### DETAILED DESCRIPTION OF THE PREFERRED EMBODIMENTS

The invention is directed to a method of driving a high definition opposed discharge plasma display panel (PDP) comprising transversely disposing a barrier rib on a center of any elongate discharge cell in any pixel of the opposed discharge PDP wherein the discharge cell is divided into two sub-cells by the barrier rib; disposing a sustain electrode on a front substrate corresponding to either sub-cell; causing a driving circuit to apply a sustaining pulse to each of the plurality of sustain electrodes in a sustaining period of each sub-field; and causing a phase of the sustaining pulse on the sustain electrode corresponding to one sub-cell to have a phase difference of 180 degrees relative to that of the sustaining pulse on the sustain electrode corresponding to the other adjacent sub-cell such that two adjacent sub-cells may discharge in opposite directions. Alternatively, the method comprises causing a phase of the sustaining pulse on the sustain electrode corresponding to one sub-cell to have a phase difference of 180 degrees relative to that of the sustaining pulse on the sustain electrode corresponding to the other spaced sub-cell such that two spaced sub-cells may discharge in opposite directions.

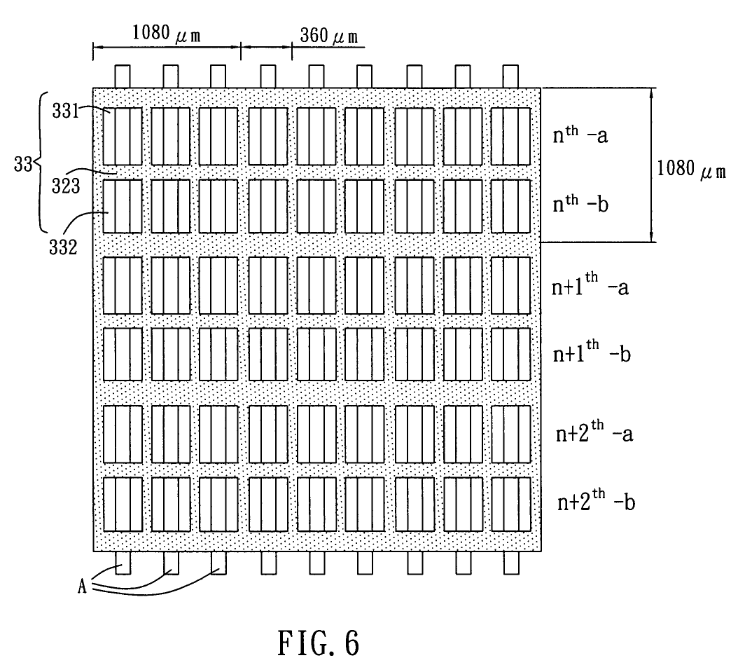

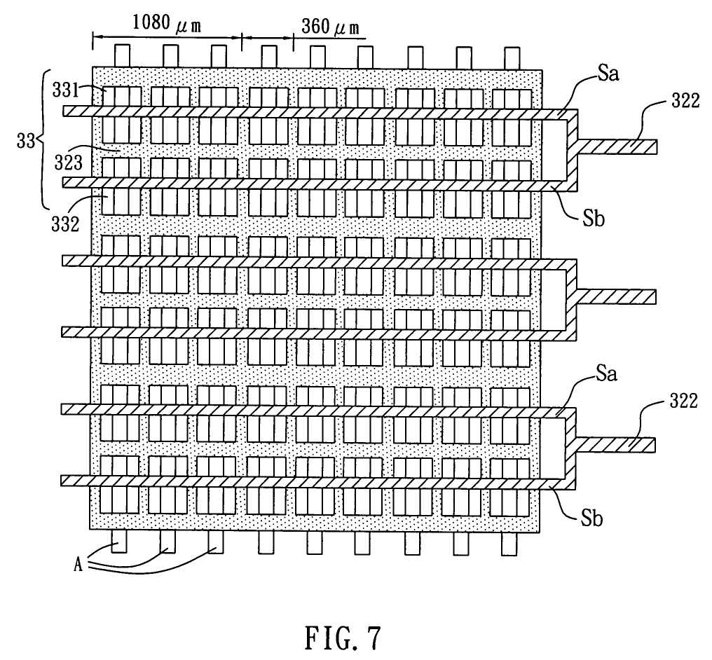

Referring to FIG. 6, a first preferred embodiment of the invention is illustrated with respect to a 34″ opposed discharge PDP. Each pixel on the opposed discharge PDP has a size of 1080 μm×1080 μm. A transverse barrier rib 323 is provided on a center of any elongate discharge cell 33 in any pixel so as to divide the discharge cell 33 into two sub-cells 331 and 332. That is, n^{th} row discharge cell is divided into n^{th}-a row sub-cell 331 and n^{th}-b row sub-cell 332. Either sub-cell 331 or 332 has a size of 1080 μm×360 μm. Referring to FIG. 7, a sustain electrode Sa and a sustain electrode Sb are provided on a front substrate of the opposed discharge PDP and corresponds to the sub-cells 331 and 332 respectively. The adjacent sub-cells 331 and 332 are parallel and one ends thereof are coupled together to receive a voltage pulse sent from an electrode line 322. Thus, a driving circuit (not shown) in the opposed discharge PDP is adapted to apply a sustaining pulse to each of a plurality of electrode lines in a sustaining period of each sub-field. As such, a phase of the sustaining pulse on the sustain electrode Sa (or Sb) corresponding to either sub-cell 331 (or 332) is adapted to have a phase difference of 180 degrees relative to that of the sustaining pulse on the sustain electrode Sa (or Sb) corresponding to the other adjacent sub-cell 331 (or 332) such that the sub-cells 331 and 332 of adjacent pixels may discharge in opposite directions.

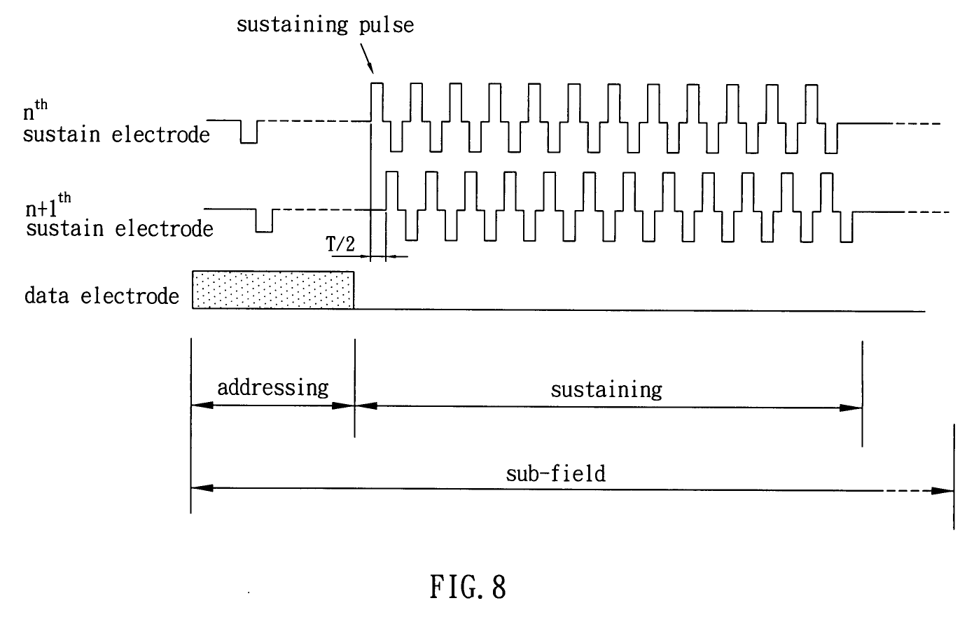

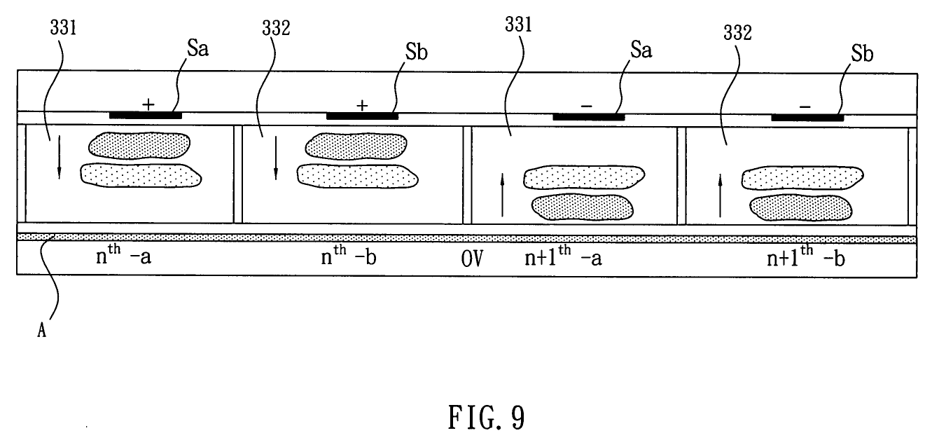

Referring to FIG. 8, a driving scheme is created by the driving circuit of the opposed discharge PDP for showing each sub-field in the first preferred embodiment. The driving scheme comprises three driving periods (i.e., a first addressing period, a second sustaining period, and a third erasing period). Referring to FIG. 9, the driving circuit applies a negative voltage pulse to each of the sustain electrodes Sa and Sb in the addressing period. At the same time, the driving circuit applies a positive data pulse to the address electrode “A” based on an image to be displayed. Next, the driving circuit applies a sustaining pulse to each of a plurality of electrode lines 322 of the opposed discharge PDP (see FIG. 7). As such, a phase of the sustaining pulse on the n^{th}-a sustain electrode Sa (or n^{th}-b sustain electrode Sb) has a phase difference of ½ period (i.e., T/2) relative to that of the sustaining pulse on the n+1^{th}-a sustain electrode Sa (or n+1^{th}-b sustain electrode Sb). That is, waveform of voltage pulse of the sub-cell 331 corresponding to odd number pixel is delayed T/2 relative to that of the sub-cell 332 corresponding to even number pixel in a sustaining period. As a result, discharge direction of the sub-cell 331 corresponding to odd number pixel is opposite to that of the sub-cell 332 corresponding to even number pixel in order to effectively eliminate noise caused by vibration of the PDP in discharge as shown in FIG. 9. Finally, the driving circuit applies an erasing pulse to each of the plurality of sustain electrodes Sa and Sb of the PDP in the erasing period. As such, wall charge of each discharge cell is eliminated. In the embodiment waveform of a sub-cell 331 corresponding to the odd number pixel is delayed T/2 relative to that of a sub-cell 332 corresponding to the even number pixel in the sustaining period. Such driving method has advantages of without modifying driving scheme in reset period and addressing period.

Referring to the above first preferred embodiment again, discharge direction (i.e., vibration direction) of the sub-cell 331 corresponding to the odd number pixel is opposite to that of the sub-cell 332 corresponding to the even number pixel. Thus, noise generated by the sub-cell 331 is opposite to that generated by the sub-cell 331 and they are cancelled each other due to opposite vibration directions. As an end, noise generated by vibration of the PDP in discharge is substantially eliminated. Moreover, a reduction of peak current and electromagnetic interference is made possible. In addition, area coated with phosphor is significantly increased because the discharge cell 33 is divided into two sub-cells 331 and 332. Further, distance between discharge center and phosphor on either upper end (or lower end) of the original discharge cell 33 is greatly decreased. As a result, UV is sufficiently employed, light emitting efficiency of phosphor is greatly improved, both light emitting efficiency and brightness of the opposed discharge PDP are greatly increased, and thus image with high quality is shown.

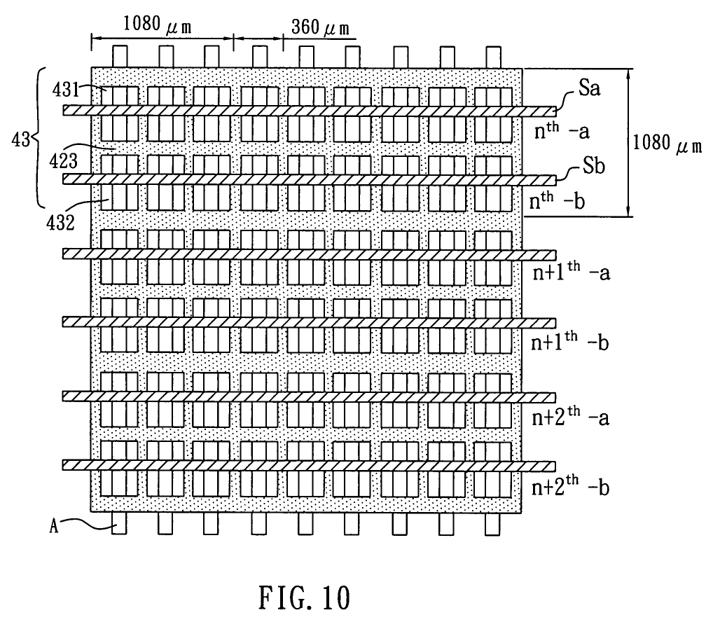

Referring to FIG. 10, a second preferred embodiment of the invention is illustrated with respect to an opposed discharge PDP. A transverse barrier rib 423 is provided on a center of any elongate discharge cell 43 in any pixel so as to divide the discharge cell 43 into two sub-cells 431 and 432. That is, n^{th} row discharge cell is divided into n^{th}-a row sub-cell 431 and n^{th}-b row sub-cell 432. A sustain electrode Sa and a sustain electrode Sb are provided on a front substrate of the opposed discharge PDP and corresponds to the sub-cells 431 and 432 respectively. Thus, a driving circuit (not shown) in the opposed discharge PDP is adapted to apply a sustaining pulse to each of a plurality of sustain electrodes Sa and Sb in a sustaining period of each sub-field. As such, a phase of the sustaining pulse on the sustain electrode Sa corresponding to the sub-cell 431 is adapted to have a phase difference of 180 degrees relative to that of the sustaining pulse on the sustain electrode Sb corresponding to the adjacent sub-cell 432 such that the sub-cells 431 and 432 of the discharge cell 43 in the same pixel may discharge in opposite directions.

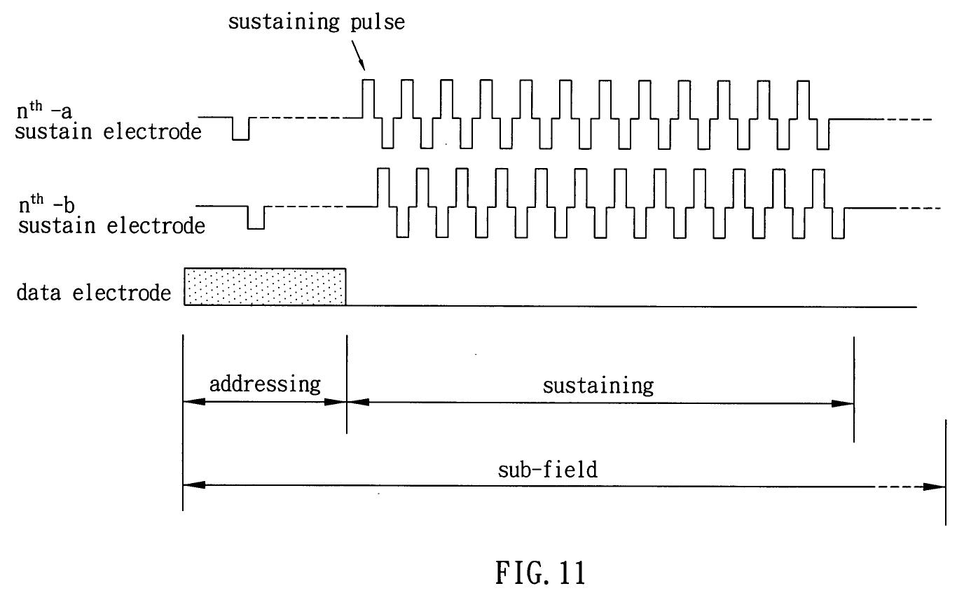

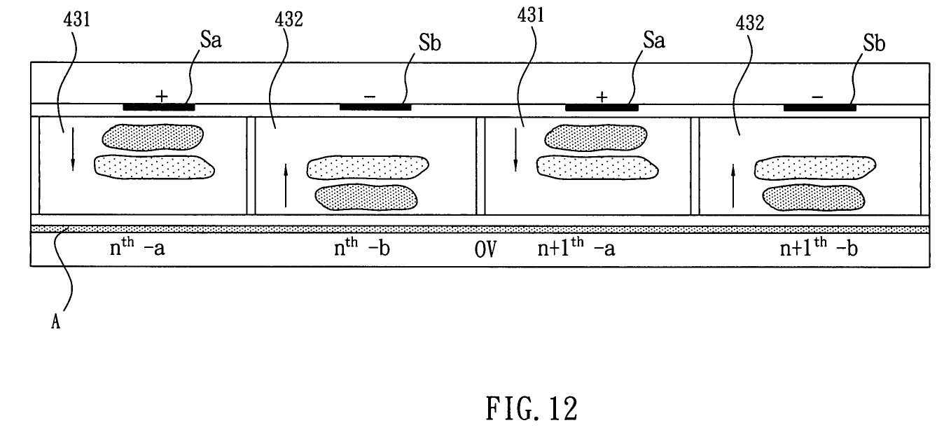

Referring to FIGS. 11 and 12, in the second preferred embodiment, the driving circuit applies a negative voltage pulse to each of the sustain electrodes Sa and Sb of the PDP for showing each sub-field in the addressing period. At the same time, the driving circuit applies a positive data pulse to the address electrode “A” based on an image to be displayed. Next, the driving circuit applies a sustaining pulse to each of a plurality of sustain electrodes Sa and Sb of the opposed discharge PDP. As such, a waveform of the sustaining pulse on the nth-a sustain electrode Sa is delayed T/2 relative to that of the sustaining pulse on the adjacent n^{th}-b sustain electrode Sb. Also, a waveform of the sustaining pulse on the n+1^{th}-a sustain electrode Sa is delayed T/2 relative to that of the sustaining pulse on the adjacent n+1^{th}-b sustain electrode Sb and so on. As a result, discharge direction of the sub-cell 431 of the discharge cell 43 is opposite to that of the sub-cell 432 thereof in the same pixel in order to effectively eliminate noise caused by vibration of the PDP in discharge as shown in FIG. 12.

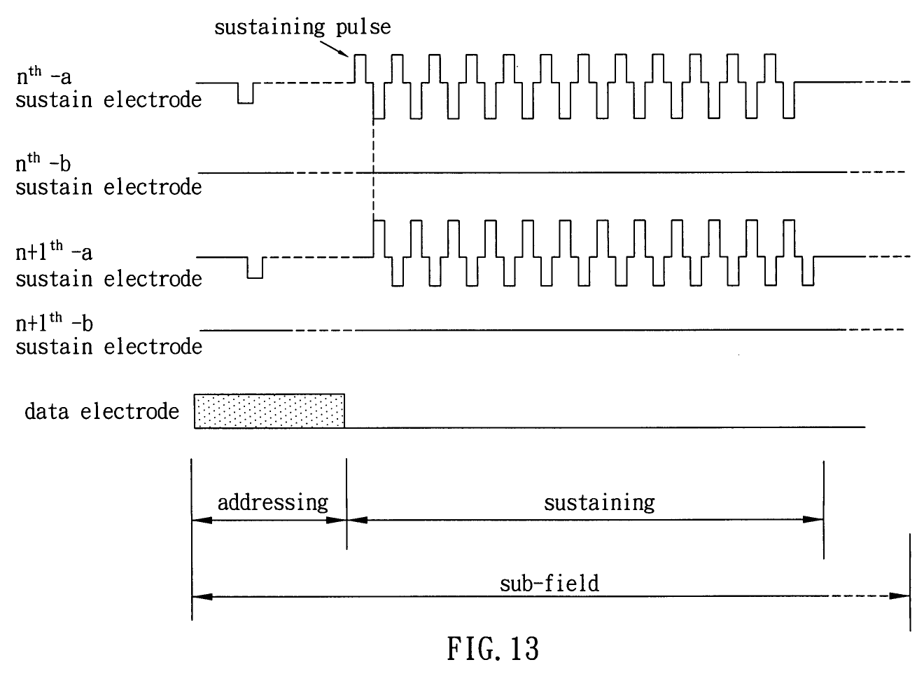

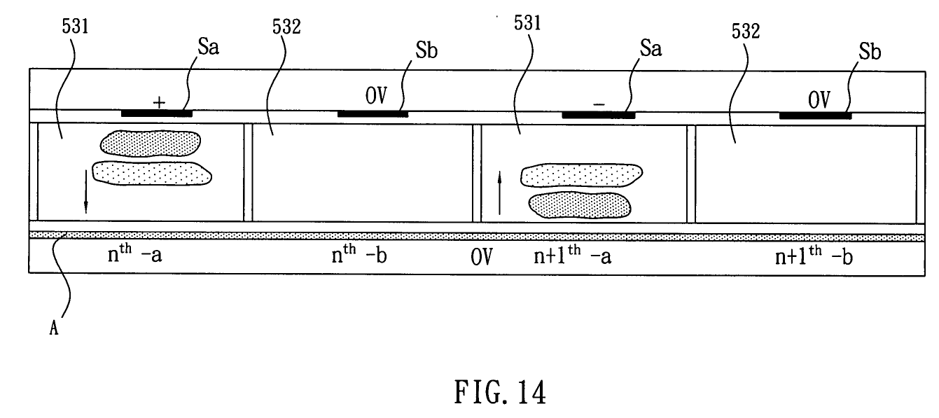

Referring to FIGS. 13 and 14, a third preferred embodiment of the invention is illustrated with respect to the same configuration of the sustain electrodes shown in FIG. 10. The driving circuit applies a negative voltage pulse to each of the sustain electrodes Sa and Sb of the PDP for showing each sub-field in the addressing period. At the same time, the driving circuit applies a positive data pulse to the address electrode “A” based on an image to be displayed. Next, the driving circuit applies a sustaining pulse to each of a plurality of spaced sustain electrodes Sa and Sb of the opposed discharge PDP. As such, a waveform of the sustaining pulse on the n^{th}-a sustain electrode Sa is delayed T/2 relative to that of the sustaining pulse on the adjacent n+1^{th}-b sustain electrode Sa. No voltage is applied to the n^{th}-b sustain electrode Sb and the n+1^{th}-b sustain electrode Sb in order to delay a waveform of the voltage pulse on the sustain electrode Sa T/2 relative to that of the voltage pulse on the spaced sustain electrode Sb in sustaining period. As a result, discharge direction of the sub-cell 531 is opposite to that of the spaced sub-cell 532 (see FIG. 14).

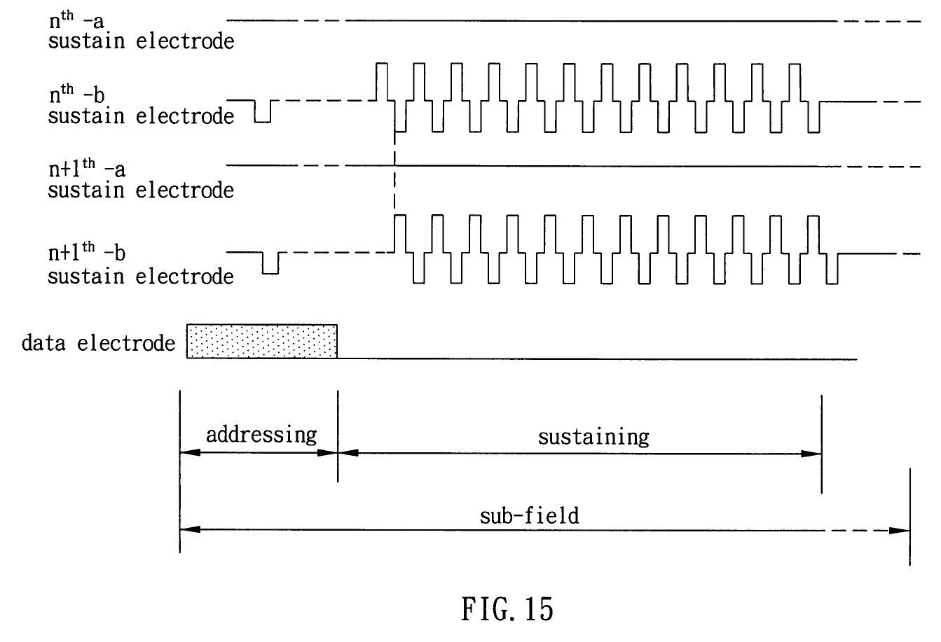

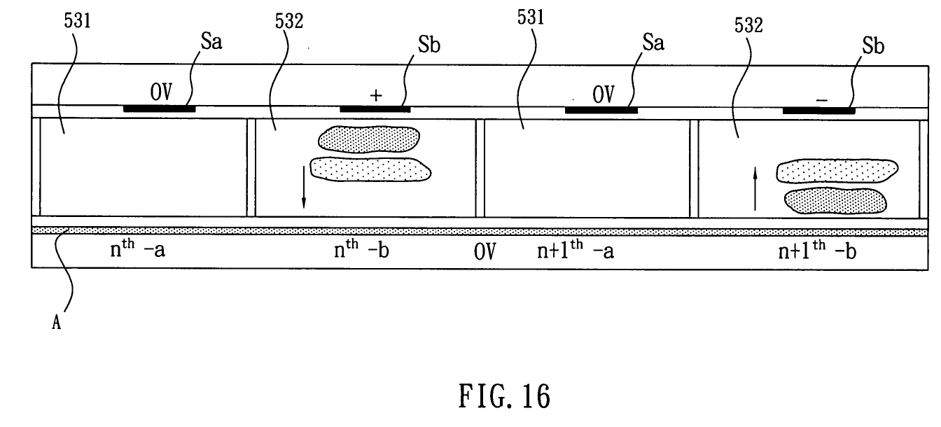

Referring to FIG. 14 in conjunction with the waveform of FIG. 13 an interlace based discharge method of the third preferred embodiment is illustrated. For showing even number fields, both the n^{th}-b and the n+1^{th}-b sustain electrodes Sb are maintained at zero potential and a phase of the waveform of the n^{th}-a sustain electrode Sa has a phase difference of 180 degrees relative to that of the n+1^{th}-a sustain electrode Sa. Likewise, referring to FIG. 16 in conjunction with the waveform of FIG. 15 for showing odd number fields, both the n^{th}-a and the n+1^{th}-a sustain electrodes Sa are maintained at zero potential and a phase of the waveform of the nth-b sustain electrode Sb has a phase difference of 180 degrees relative to that of the n+1^{th}-b sustain electrode Sb. Thus, the n^{th}-a sustain electrode Sa is a sustain electrode adapted to drive independently relative to the n^{th}-b sustain electrode Sb and vice versa in order to control waveforms of the n^{th}-a sustain electrode Sa and the n^{th}-b sustain electrode Sb respectively. As an end, brightness of the corresponding sub-cell 531 can be controlled. Also, the n+1^{th}-a sustain electrode Sa is a sustain electrode adapted to drive independently relative to the n+1^{th}-b sustain electrode Sb and vice versa in order to control waveforms of the n+1^{th}-a sustain electrode Sa and the n+1^{th}-b sustain electrode Sb respectively. As an end, brightness of the corresponding sub-cell 532 can be controlled. For example, in a period of showing a specific sub-field waveform of voltage pulse the n^{th}-a sustain electrode Sa is maintained as the waveform of voltage pulse in sustaining period and voltage of the n^{th}-b sustain electrode Sb is maintained as constant. As such, only sub-cell 531 corresponding to the n^{th}-a sustain electrode Sa may discharge to emit light while sub-cell 532 corresponding to the n^{th}-b sustain electrode Sb may not discharge (i.e., no light is emitted). Such independent brightness control with respect to the sub-cell 531 (or the sub-cell 532) corresponding to the n^{th}-a sustain electrode Sa and the n^{th}-b sustain electrode Sb has the following advantages:

(i) A minimum brightness can be obtained. The sub-cell 531 corresponding to the n^{th}-a sustain electrode Sa may discharge to emit light while the sub-cell 532 corresponding to the n^{th}-b sustain electrode Sb is dark due to no light emission. Thus, brightness of the opposed discharge PDP is about half of that when both the sub-cell 531 corresponding to the n^{th}-a sustain electrode Sa and the sub-cell 532 corresponding to the n^{th}-b sustain electrode Sb are lit. As a result, a minimum brightness is obtained for rendering fine image in low gray-scales of the opposed discharge PDP.

(ii) Brightness in discharge can be finely adjusted. Either the sub-cell 531 corresponding to the nth-a sustain electrode Sa or the sub-cell 532 corresponding to the n^{th}-b sustain electrode Sb can be prohibited from discharging when brightness in discharge is higher than an ideal value. As a result, brightness of the opposed discharge PDP is decreased and thus the purpose of adjusting brightness of each gray-scale is obtained.

While the invention herein disclosed has been described by means of specific embodiments, numerous modifications and variations could be made thereto by those skilled in the art without departing from the scope and spirit of the invention set forth in the claims.

What is claimed is:

1. A method of driving a high definition opposed discharge plasma display panel (PDP) comprising:
transversely disposing a barrier rib on a center of any one of a plurality of elongate discharge cells in any one of a plurality of pixels of the opposed discharge PDP wherein the discharge cell is divided into two sub-cells by the barrier rib;
disposing a sustain electrode on a front substrate corresponding to either sub-cell;
causing a driving circuit to apply a sustaining pulse to each of the plurality of sustain electrodes in a sustaining period of each sub-field; and
causing a phase of the sustaining pulse on the sustain electrode corresponding to one sub-cell to have a phase difference of 180 degrees relative to that of the sustaining pulse on the sustain electrode corresponding to the other adjacent sub-cell.

2. A method of driving a high definition opposed discharge plasma display panel (PDP) comprising:
transversely disposing a barrier rib on a center of any one of a plurality of elongate discharge cells in any one of a plurality of pixels of the opposed discharge PDP wherein the discharge cell is divided into two sub-cells by the barrier rib;
disposing a sustain electrode on a front substrate corresponding to either sub-cell;
causing a driving circuit to apply a sustaining pulse to each of the plurality of sustain electrodes in a sustaining period of each sub-field; and
causing a phase of the sustaining pulse on the sustain electrode corresponding to one sub-cell to have a phase difference of 180 degrees relative to that of the sustaining pulse on the sustain electrode corresponding to the other spaced sub-cell.

3. The method of claim 2, further comprising causing a phase of the sustaining pulse on the sustain electrode corresponding to one sub-cell of the discharge cell to be equal to that of the sustaining pulse on the sustain electrode corresponding to the other adjacent sub-cell of the same discharge cell.

4. The method of claim 2, further comprising causing the sustaining pulse on the sustain electrode corresponding to the other sub-cell of the same discharge cell to have a zero potential.
